(19) United States
(12) Patent Application Publication
(10) Pub. No.: US 2025/0070309 A1
(43) Pub. Date: Feb. 27, 2025

(54) BATTERY MODULE AND BATTERY PACK INCLUDING SAME

(71) Applicant: SK ON CO., LTD., Seoul (KR)

(72) Inventors: Jeong-Woo HAN, Daejeon (KR); Hae-Ryong JEON, Daejeon (KR); Bon-Seok KU, Daejeon (KR)

(21) Appl. No.: 18/943,652

(22) Filed: Nov. 11, 2024

Related U.S. Application Data
(63) Continuation of application No. PCT/KR2023/006703, filed on May 17, 2023.

(30) Foreign Application Priority Data
Sep. 14, 2022 (KR) 10-2022-0115766

(51) Int. Cl. H01M 10/6557; H01M 10/613; H01M 10/658; H01M 50/211

(52) U.S. Cl. CPC H01M 10/6557; H01M 10/613; H01M 10/658; H01M 50/211

(57) ABSTRACT

A battery pack based on an embodiment of the disclosed technology may comprise: a pack housing including an inner space; and at least one battery module accommodated in the internal space of the pack housing and including a plurality of sub battery modules, wherein the plurality of sub battery modules include a plurality of cell stacks each of which comprises a plurality of battery cells stacked in a first direction and which are arranged in a second direction, and a plurality of partition walls are included between the plurality of cell stacks to exchange heat with the plurality of battery cells or block thermal propagation between the sub battery modules.

### PRIORITY CLAIMS AND RELATED PATENT APPLICATIONS

This patent document is a continuation application of, and claims the priority and benefits of, PCT Application No. PCT/KR2023/006703, filed on May 17, 2023, which claims the priority and benefits of Korean Patent Application No. 10-2022-0115766 filed on Sep. 14, 2022. The entire contents of the above applications are incorporated by reference as part of the disclosure of this patent document.

### TECHNICAL FIELD

The disclosed technology relates to a battery module and a battery pack including the same.

### BACKGROUND

A secondary battery, unlike a primary battery, can be recharged and used repeatedly, making it suitable as an energy source for various applications, such as digital cameras, laptop computers, mobile devices, electric vehicles, and hybrid vehicles.

Among secondary batteries, the most common type is a lithium secondary battery. Other examples include nickel-cadmium batteries, nickel-metal hydride batteries, and more.

### SUMMARY

The disclosed technology can be implemented in some embodiments to provide a battery module with flexible structural expandability and a battery pack including such a battery module.

The disclosed technology can be implemented in some embodiments to provide a battery module with guaranteed thermal stability and a battery pack including such a battery module.

In an aspect of the disclosed technology, a battery pack includes: a pack housing including an internal space; and at least one battery module accommodated in the internal space of the pack housing and including a plurality of sub battery modules, wherein the plurality of sub battery modules include a plurality of cell stacks each including a plurality of battery cells stacked in a first direction, the plurality of cell stacks being arranged in a second direction, and a plurality of partition walls are disposed between the plurality of cell stacks to exchange heat with the plurality of battery cells or block thermal propagation between the sub battery modules. In an embodiment, each of the plurality of sub battery modules includes a plurality of cell stacks.

A first partition wall may be disposed between the plurality of cell stacks included in each of the sub battery modules and exchanges heat with the plurality of battery cells, and the first partition wall may include a refrigerant path.

The battery pack may further include a heat dissipation member disposed between the first partition wall and the plurality of cell stacks.

A second partition wall may be disposed between the sub battery modules to insulate the sub battery modules from each other, and the second partition wall may include an insulating member.

The battery pack may further include the first partition wall disposed between the pack housing and the battery module.

The battery pack may further include a pack cover disposed to cover the battery module, wherein at least some of the plurality of partition walls are provided in the pack housing or the pack cover.

The sub battery module may include a connection portion capable of being coupled in a second direction for the battery modules to be connected to each other in the second direction, and the adjacent sub battery modules may be coupled to each other by using the connection portion.

The battery module may include two first sub battery modules disposed outside the battery module in a length direction, and selectively include a second sub battery module disposed between the two first sub battery modules.

In another aspect of the disclosed technology, a battery pack includes: a plurality of cell stacks including a plurality of battery cells stacked in a first direction; a pack housing having an internal space for accommodating the plurality of cell stacks; and a pack cover coupled to the pack housing to cover the plurality of cell stacks, wherein the pack housing and the pack cover respectively include a lower partition wall and an upper partition wall extending toward each other, the lower partition wall and the upper partition wall cooperate with each other to form a second partition wall partitioning the internal space, and the second partition wall insulates at least some of the cell stacks among the plurality of cell stacks from each other.

The battery pack may further include a first partition wall disposed to face at least some side surfaces of the plurality of cell stacks, wherein the first partition wall includes a refrigerant path.

In another aspect of the disclosed technology, a battery module includes a plurality of sub battery modules including first and second cell stacks each including a plurality of battery cells stacked in a first direction, the first and second cell stacks being arranged in a second direction, and a sub module frame facing the first and second cell stacks in the first direction and the second direction, wherein the sub module frame includes a connection portion extending from the sub module frame in the second direction for the sub battery modules to be connected to each other in the second direction.

The sub module frame may include first and third frames extending in the second direction and disposed on at least one side among the one side and the other side in the first direction, and a second frame extending in the first direction and disposed between at least the first and second cell stacks.

The first frame may include a first connection portion including a closed part coupled to the second frame and an open part spaced apart from the second frame to form a gap, and the third frame may include a second connection portion including a closed part coupled to the second frame.

The first or second connection portion of the adjacent sub battery modules may be disposed in the open part.

The sub battery modules may include two first sub battery modules disposed outside the module in the second direction and including the first to the third frames, and selectively include a second sub battery module disposed between the two first sub battery modules and including the first and the second frames.

The second frame may include either a refrigerant path or an insulating member.

In an aspect of the disclosed technology, the battery module and the battery pack including the battery module may be freely expanded in the horizontal, vertical, and height directions, allowing them to be manufactured to satisfy the size specification required by various vehicle models.

In addition, the battery module and the battery pack including the battery module based on an embodiment of the disclosed technology may reduce manufacturing costs while improving thermal stability and energy density by optimizing the arrangement of the cooling structure and the insulation structure.

### BRIEF DESCRIPTION OF DRAWINGS

FIG. 1 is a partially exploded perspective view of a battery pack based on an embodiment of the disclosed technology.

FIG. 2 is an exploded perspective view of a battery module based on an embodiment of the disclosed technology.

FIG. 3 is a perspective view of a sub battery module based on an embodiment of the disclosed technology.

FIG. 4 is a side view of the battery module including a first partition wall based on an embodiment of the disclosed technology.

FIG. 5 is a side view of a battery module based on an embodiment of the disclosed technology.

FIG. 6 is a side view of a battery module including a second partition wall based on an embodiment of the disclosed technology.

FIG. 7 is a side view of a battery module based on another embodiment of the disclosed technology.

FIG. 8 is a side view of a battery module based on an embodiment of the disclosed technology.

FIGS. 9A and 9B are views each showing sub battery modules based on an embodiment of the disclosed technology.

FIG. 10 is a view showing the battery module including the sub battery modules shown in FIGS. 9A and 9B.

FIG. 11 is a side view of a battery pack based on an embodiment of the disclosed technology.

FIGS. 12A and 12B are views showing various embodiments of region A of FIG. 11.

### DETAILED DESCRIPTION

In some embodiments of the disclosed technology, terms such as “upper side,” “upper part,” “lower side,” “lower part,” “side surface,” “front surface,” “rear surface,” and the like are used with reference to directions or orientations shown in the drawings, and these terms may vary if the directions or orientations of the referenced components changes.

In addition, terms with ordinal numbers, such as “first” and “second,” are used in the specification to describe various components. However, these terms are not limiting and are simply used to distinguish one component and another. For example, a first component may be referred to as a second component, and vice versa.

Hereinafter, the various embodiments of the disclosed technology are described in detail with reference to the accompanying drawings.

A secondary battery may be manufactured and used as a rigid square or cylindrical type battery cell or as a flexible pouch-type battery cell. In products that require high output, such as electric vehicles, the secondary battery may be configured as a battery module including one or more cell stacks of a plurality of battery cells, or a battery pack that includes one or more of these battery modules.

The size of a battery module or battery pack can be adjusted based on the number of battery cells it contains. For example, because pouch-type battery cells can be arranged vertically, the horizontal and vertical lengths of the battery module or battery pack can be easily adjusted by changing the number of pouch-type cells. However, the height of the battery module or battery pack is determined by the height of each pouch-type cell, which limits flexibility and poses a challenge in designing battery packs that fit the space available in various vehicle models.

Therefore, there is a need to develop a battery module or battery pack that allows for flexible adjustment of its length, width, and height to fit the available space.

In addition, it is necessary to appropriately arrange a cooling structure to remove heat generated in the battery module or battery pack, as well as an insulation structure to delay heat transfer to adjacent battery modules and battery packs in the event of an incident, based on the arrangement of the battery module or battery pack.

The disclosed technology can be implemented in some embodiments to provide a battery module with flexible structural expansion and guaranteed thermal stability and a battery pack including the same.

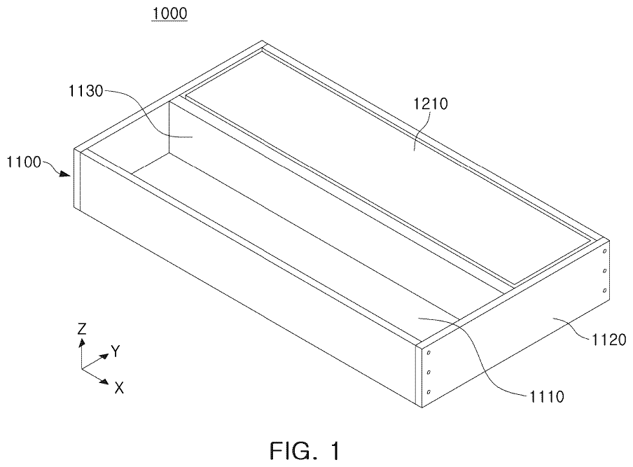

FIG. 1 is a partially exploded perspective view of a battery pack based on an embodiment of the disclosed technology.

Referring to FIG. 1, a battery pack 1000 based on an embodiment of the disclosed technology may include a pack housing 1100. In some implementations, the battery pack 1000 may further include a pack cover (not shown).

The pack housing 1100 may include a tray 1110 and a side frame 1120. The tray 1110 may be in the form of a plate, forming a bottom surface of the pack housing 1100. The side frames 1120 may be arranged along a perimeter of the tray 1110. The tray 1110 and the side frames 1120 may form an internal space of the pack housing 1100, and a plurality of battery modules 100 may be disposed in the internal space. In addition, an electrical component may be disposed on one side of the internal space of the pack housing 1100.

The pack housing 1100 may include a center beam 1130. The center beam 1130 may be disposed in the internal space of the pack housing 1100. The center beam 1130 may partition the internal space of the pack housing 1100, in which the plurality of battery modules 100 are disposed.

Referring to FIG. 1, the center beam 1130 may partition the internal space of the pack housing 1100 into two zones. In an implementation, as shown in FIG. 1, the battery module 100 is disposed in only one of the two zones partitioned by the center beam 1130. In another implementation, the battery module 100 may be disposed in the remaining zone as well.

Referring to FIG. 1, the battery modules 100 disposed in different zones may be covered by different covers. For example, the center beam 1130 may partition the internal space of the pack housing 1100 into a first space and a second space, and the battery module 100 disposed in the first space and the battery module 100 disposed in the second space may be respectively covered by a sub pack cover 1210.

The pack cover may be disposed to cover the top of the pack housing 1100. The pack cover may simultaneously cover both the battery module 100 disposed in the first space and the battery module 100 disposed in the second space. That is, the pack cover may simultaneously cover the plurality of battery modules 100 disposed in the internal space of the pack housing 1100. Here, considering the safety of the battery pack 1000, a separate insulating member may be disposed between the pack cover and the plurality of battery modules 100. The insulating member may include an insulating material.

In an embodiment, as shown in FIG. 1, the internal space of the pack housing 1100 is partitioned into two zones. However, in an embodiment, the internal space of the pack housing 1100 may be partitioned into more than two zones depending on the number of the center beams 1130.

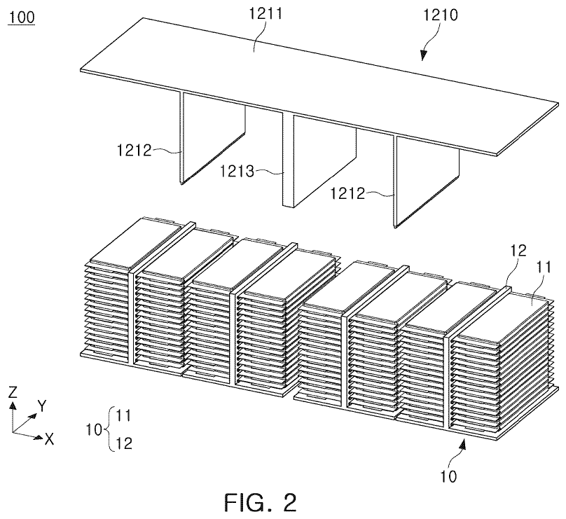

FIG. 2 is an exploded perspective view of a battery module based on an embodiment of the disclosed technology.

Specifically, FIG. 2 shows a battery module 100 that is disposed in the first zone or the second zone described above.

Referring to FIG. 2, the battery module 100 based on an embodiment of the disclosed technology may include a plurality of sub battery modules 10 and the sub pack cover 1210.

In an embodiment of the disclosed technology, the battery module 100 may include the plurality of sub battery modules 10 arranged in one direction (e.g., X-direction in the drawings) and the sub pack cover 1210 extending in the direction in which the plurality of sub battery modules 10 are arranged, simultaneously covering the plurality of sub battery modules 10.

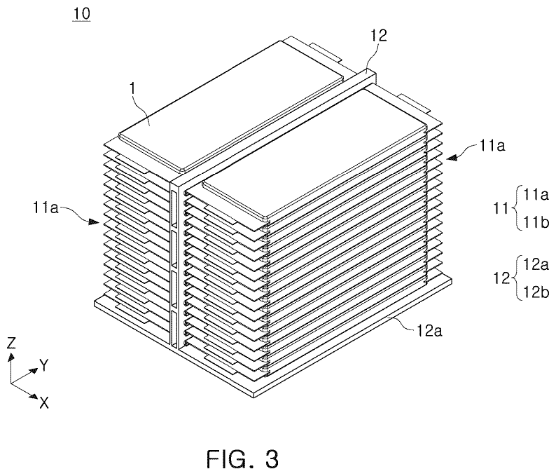

First, referring to FIG. 3, the sub battery module 10 included in the battery module 100 based on an embodiment of the disclosed technology will be discussed.

FIG. 3 is a perspective view of a sub battery module based on an embodiment of the disclosed technology.

In an embodiment of the disclosed technology, the sub battery module 10 may include two cell stacks 11 (e.g., first cell stack 11a and second cell stack 11b) and a sub module frame 12.

The cell stack 11 may include a plurality of battery cells 1 stacked in one direction (e.g., Z-direction in the drawings). The plurality of battery cells 1 may be the pouch type battery cells and may be arranged in a horizontal orientation, stacked in the Z-direction (or first direction).

By arranging the pouch type battery cells in a horizontal orientation as discussed above, the x-direction and y-direction lengths of the battery module 100 or the battery pack 1000 as well as its z-direction length may be easily adjusted as shown in the drawings. In some implementations, the X-direction and Y-direction lengths of the battery module 100 or the battery pack 1000 may be adjusted based on the number of the sub battery modules 10, and its Z-direction length may be adjusted based on the number of the battery cells 1. Therefore, the structural expansion of the battery module 100 or the battery pack 1000 may be flexible.

The sub module frame 12 may include a lower frame 12a and a side frame 12b. Here, the side frame 12b of the sub module frame 12 is different from the side frame of the pack housing.

The lower frame 12a may form a bottom surface of the sub module frame 12, and the cell stack 11 may be disposed on the lower frame 12a. For example, the sub battery module 10 may include the first cell stack 11a and the second cell stack 11b, and the first and second cell stacks 11a and 11b may be disposed on the lower frame 12a to be spaced apart from each other in a direction (e.g., X-direction or a second direction in the drawings) perpendicular to the Z-direction.

Although not shown in the drawings, a compressible member (not shown) may be disposed between the cell stack 11 and the lower frame 12a. Furthermore, the compressible members may be disposed at regular gap or intervals between the plurality of battery cells 1 included in the cell stack 11. The compressible member may include an insulating material. For example, the compressible member may include a material such as polyurethane, silicone, or aerogel.

The side frame 12b may be disposed on the lower frame 12a, and may extend in the stacking direction (e.g., Z-direction in the drawings) of the plurality of battery cells 1. For example, the lower frame 12a and the side frame 12b may be perpendicular to each other.

The side frame 12b may be disposed between the first and second cell stacks 11a and 11b, which are disposed on the lower frame 12a. Accordingly, side surfaces of the first and second cell stacks 11a and 11b may face the side frame 12b.

The side frame 12b may function as a heat exchanger. The side frame 12b may include a refrigerant path through which a refrigerant flows. The refrigerant may be a fluid, for example, a coolant. The side frame 12b may include an inlet through which the refrigerant flows in and an outlet through which the refrigerant flows out. The refrigerant entering through the inlet may flow through the refrigerant path and be discharged through the outlet.

In this way, the first and second cell stacks 11a and 11b may extend in the stacking direction of the plurality of battery cells 1 through the side surface to be in contact with the side frame 12b, which functions as a heat exchanger, and the two cell stacks 11a and 11b may share one side frame 12b, thereby providing the improved heat dissipation efficiency and energy density.

In an embodiment, the side frame 12b may also function as a heat shield.

Referring back to FIG. 2, the battery module 100 may include the sub pack cover 1210 simultaneously covering the plurality of sub battery modules 10.

The sub pack cover 1210 may include a top plate 1211 and a plurality of partition walls (e.g., a first partition wall 1212 and a second partition wall 1213).

The top plate 1211 may be disposed on the top of the plurality of sub battery modules 10. The top plate 1211 may extend in an arrangement direction (e.g., X-direction in the drawings) of the plurality of sub battery modules 10 to simultaneously cover the plurality of sub battery modules 10.

The first and second partition walls 1212 and 1213 may be disposed on the top plate 1211 and extend in the stacking direction (e.g., Z-direction in the drawings) of the plurality of battery cells 1. For example, the top plate 1211 and the first or second partition wall 1212 or 1213 may be perpendicular to each other.

The first or second partition wall 1212 or 1213 may be disposed between two adjacent sub battery modules 10. Accordingly, side surfaces of the two adjacent sub battery modules 10 may face the first or second partition wall 1212 or 1213.

The first and second partition walls 1212 and 1213 may be distinguished from each other by their shapes and functions. The first and second partition walls 1212 and 1213 may be formed to have different thicknesses and each function as the heat exchanger or the heat shield. For example, the first partition wall 1212 may function as the heat exchanger, the second partition wall 1213 may function as the heat shield, and the second partition wall 1213 may be thicker than the first partition wall 1212.

As shown in FIG. 2, in an embodiment, the sub pack cover 1210 may include both the first partition wall 1212 and the second partition wall 1213. However, in an embodiment, the sub pack cover 1210 may include at least one of the first partition wall 1212 and the second partition wall 1213.

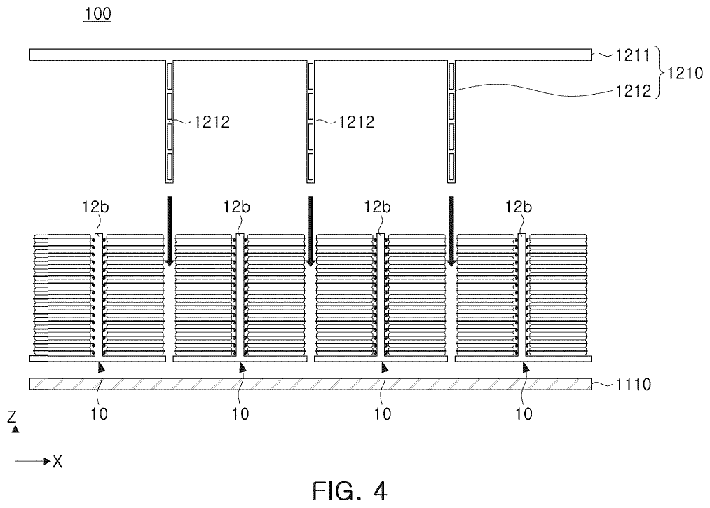

FIG. 4 is a side view of the battery module including the first partition wall based on an embodiment of the disclosed technology.

Referring to FIG. 4, the first partition wall 1212 may be disposed between the plurality of sub battery modules 10 included in the battery module 100. That is, in an embodiment shown in FIG. 4, the sub pack cover 1210 may include the first partition wall 1212 without including the second partition wall 1213.

The first partition wall 1212 may function as the heat exchanger as described above. The first partition wall 1212 may include the refrigerant path through which the refrigerant flows. The refrigerant may be a fluid, for example, a coolant. The first partition wall 1212 may include an inlet through which the refrigerant flows in and an outlet through which the refrigerant flows out. The refrigerant flowing in through the inlet may flow in the refrigerant path and be discharged through the outlet.

In an embodiment shown in FIG. 4, all the sub battery modules 10 included in the battery module 100 may have at least one side surface in contact with the first partition wall 1212, and heat exchange may thus be performed on two side surfaces of at least one cell stack 11 included in the sub battery module 10.

As discussed above, in an embodiment, the first partition wall 1212 is disposed between two adjacent sub battery modules 10. However, in an embodiment, the first partition wall 1212 may also be disposed between the sub battery module 10 and the side frame 1120. In this case, all the sub battery modules 10 included in the battery module 100 may have two side surfaces in contact with the first partition wall 1212. Accordingly, the heat exchange may be performed on the two side surfaces of each of all the cell stacks 11 included in the sub battery modules 10.

In this way, the heat dissipation efficiency and a thermal resistance value may be improved when the first partition wall 1212, which functions as a heat exchanger, is disposed between the plurality of sub battery modules 10. In addition, in the case of a structure in which two adjacent sub battery modules 10 share the first partition wall 1212, the battery module 100 or the battery pack 1000 may include more sub battery modules 10, thereby maximizing cost-saving effects.

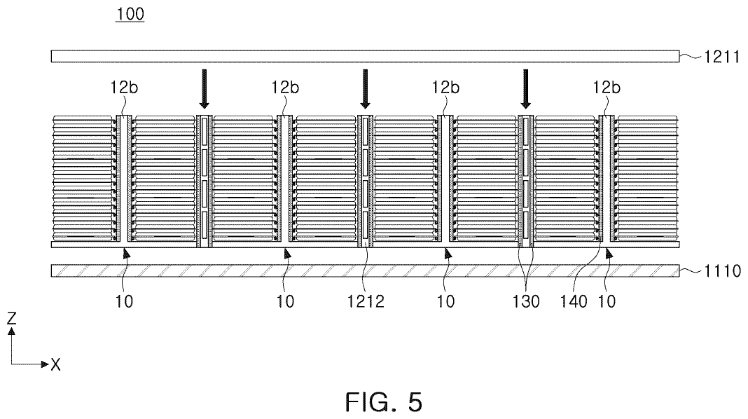

FIG. 5 is a side view of a battery module based on an embodiment of the disclosed technology.

Referring to FIG. 5, the first partition wall 1212 may be disposed on the tray 1100 rather than being disposed on the top plate 1211.

In an embodiment, the battery module shown in FIG. 5 may be the same as the battery module shown in FIG. 4 except for a location where the first partition wall 1212 is disposed.

In some implementations, the battery module may further include a heat dissipation member 130 disposed between the cell stack 11 and the side frame 12b or between the sub battery module 10 and the first partition wall 1212. For example, the heat dissipation member 130 may be a material having a high thermal conductivity and adhesive strength.

A gap may be formed between the cell stack 11 and the side frame 12b or between the sub battery module 10 and the first partition wall 1212, and the heat dissipation member 130 may fill the gap to assist heat transfer among the plurality of battery cells 10, the side frame 12b, and the first partition wall 1212.

In an, if the side frame 12b is the heat shield, an insulating member 140 described below may be disposed between the cell stack 11 and the side frame 12b.

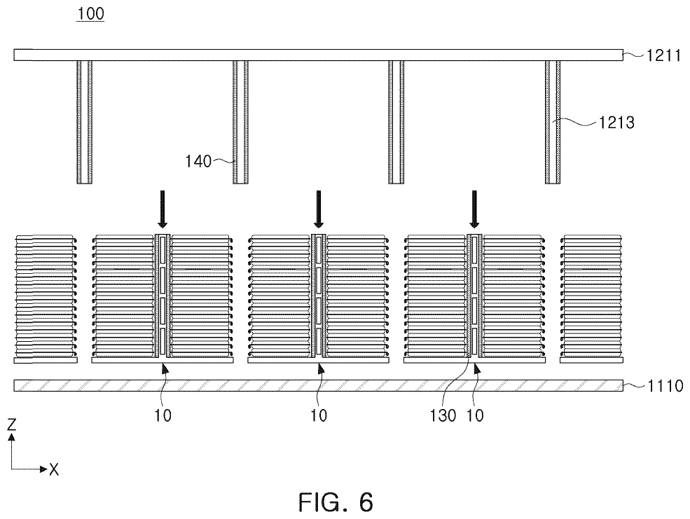

FIG. 6 is a side view of a battery module including the second partition wall based on an embodiment of the disclosed technology.

Referring to FIG. 6, the second partition wall 1213 may be disposed between the plurality of sub battery modules 10 included in the battery module 100. That is, in an embodiment shown in FIG. 6, the sub pack cover 1210 may include the second partition wall 1213 without including the first partition wall 1212.

The second partition wall 1213 may function as the heat exchanger as described above. The second insulating layer 1213 may include the insulating material. The insulating member may be a material having a low thermal conductivity, and may be a material having a thermal conductivity of 0.3 (W/mK) or less. For example, the insulating member may include aerogel, ceramic wool, mica sheet, fire resistive paint, or others.

In an embodiment, the second partition wall 1213 may be provided in the form of a sandwich panel in which the insulating members described above are disposed on two surfaces of the partition wall made of aluminum or steel.

In an embodiment shown in FIG. 6, all the sub battery modules 10 included in the battery module 100 may have at least one side surface in contact with the second partition wall 1213.

In an embodiment, as discussed above, the second partition wall 1213 is disposed between two adjacent sub battery modules 10. However, in an embodiment, the second partition wall 1212 may also be disposed between the sub battery module 10 and the side frame 1120. In this case, all the sub battery modules 10 included in the battery module 100 may have the two side surfaces in contact with the second partition wall 1213, thus blocking the heat transfer between the adjacent sub-battery modules 10 in the battery module 100.

In this way, when the second partition wall 1213, which functions as the heat shield, is disposed between the plurality of sub battery modules 10, thermal propagation to another adjacent disposed sub battery module 10 may be blocked or delayed even if an event occurs in one of the sub battery modules 10 in the battery module 100. In addition, the transfer of flame and ash may also be blocked.

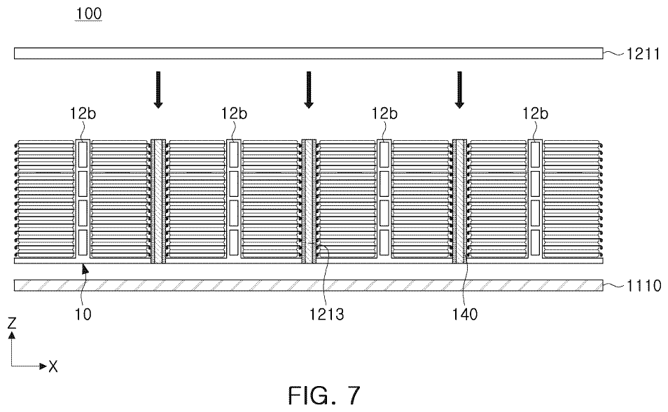

FIG. 7 is a side view of a battery module based on an embodiment of the disclosed technology.

Referring to FIG. 7, the second partition wall 1213 may be disposed on the tray 1110 rather than being disposed on the top plate 1211.

In an embodiment, the battery module shown in FIG. 7 may be the same as the battery module shown in FIG. 6 except for a location where the second partition wall 1213 is disposed.

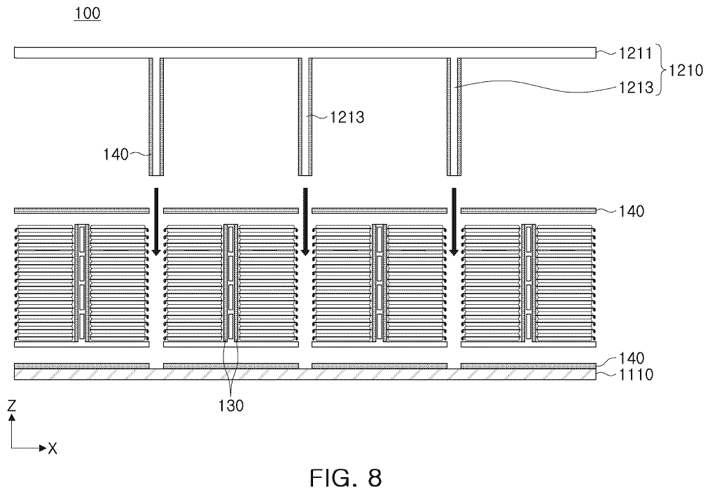

FIG. 8 is a side view of a battery module based on an embodiment of the disclosed technology.

Referring to FIG. 8, the insulating member 140 may be further disposed on the top and bottom of the battery module 100 in order to prevent the thermal propagation occurring between the plurality of sub battery modules 10 included in the battery module 100.

In some implementations, the insulating member 140 may be disposed on the top and/or bottom of the sub battery module 10. For example, the insulating members 140 may be disposed between the sub battery module 10 and the tray 1110 and between the sub battery module 10 and the sub pack cover 1120.

In some implementations, an outermost component in the battery module 100 or the battery pack 1000 may be made of a material having the high thermal conductivity such as aluminum or steel. Accordingly, the thermal propagation between the sub battery modules 10 may be more reliably blocked by further disposing the insulating member 140 between the sub battery modules 10 and the above-mentioned components.

The insulating member may be a material having the low thermal conductivity, and may be a material having the thermal conductivity of 0.3 (W/mK) or less. For example, the insulating member may include aerogel, ceramic wool, mica sheet, fire resistive paint, or others.

Next, the sub battery modules 20 and 30 based on an embodiment of the disclosed technology and a battery module 200 including the sub battery modules 20 and 30 will be described.

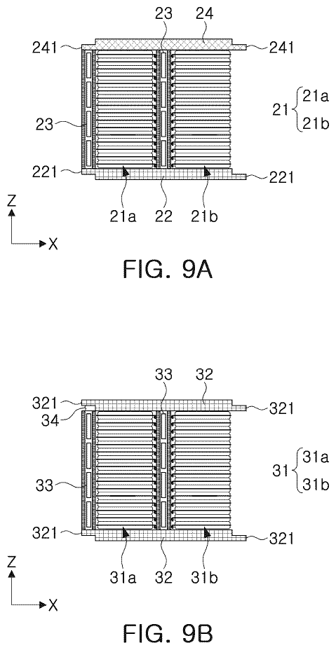

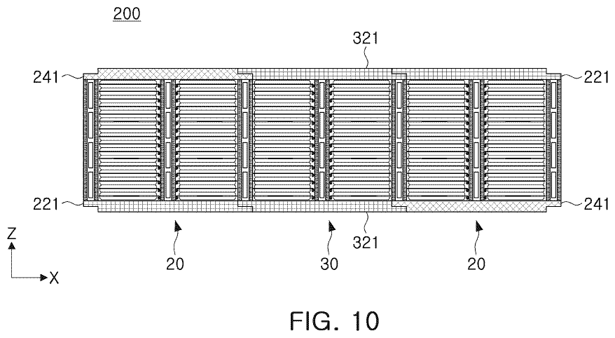

FIGS. 9A and 9B are views each showing the sub battery modules based on an embodiment of the disclosed technology, and FIG. 10 is a view showing the battery module including the sub battery modules in FIGS. 9A and 9B.

In an embodiment of the disclosed technology, the sub battery modules 20 and 30 shown in FIGS. 9A and 9B may be combined to form the battery module 200 shown in FIG. 10.

The battery module 200 shown in FIG. 10 may be accommodated in the internal space of the battery pack 1000 shown in FIG. 1. The battery module 200 may be disposed in the first space or the second space partitioned by the center beam 1130 of the pack housing 1100 as shown in FIG. 1.

The battery module shown in FIG. 10 may include the sub battery modules 20 and 30 (e.g., the first and second sub battery modules) shown in FIGS. 9A and 9B.

The first sub battery module 20 may be disposed outside the battery module 200, and the second sub battery module 30 may be disposed inside the battery module 200. For example, the first sub battery module 20 may be disposed between the pack housing 1100 and the second sub battery module 30, and the second sub battery module 30 may be disposed between the second sub battery modules 30 or between the first sub battery module 20 and the second sub battery module 30.

In an embodiment of the disclosed technology, the battery module 200 may include two first sub battery modules 20 and selectively include at least one second sub battery module 30. That is, the battery module 200 may adjust the number of the second sub battery modules 30 to thus adjust a length of the battery module 200 in a horizontal direction (X-direction or the second direction based on the drawings).

In an embodiment of the disclosed technology, the first sub battery module 20 and the second sub battery module 30 may have different structures.

The first and second sub battery modules 20 and 30 may each include two cell stacks 21 and 31 and the sub module frame. That is, the first and second sub battery modules 20 and 30 may each include the first and second cell stacks and the sub module frame. The first and second cell stacks may be disposed on the sub module frame to be spaced apart from each other in the X-direction (or second direction).

The cell stacks 21 or 31 may include a plurality of battery cells stacked in one direction (e.g., Z-direction in the drawings). The plurality of battery cells may be the pouch type battery cells, arranged in a horizontal orientation, and stacked in the Z-direction. Accordingly, the length of the battery module 200 in the Z-direction may be adjusted based on the number of the plurality of battery cells included in the cell stacks 21 or 31.

The sub module frame may include a first frame 22 or 32 and a second frame 23 or 33, and selectively include a third frame 24.

Referring to FIG. 9A, the sub module frame of the first sub battery module 20 may include the first frame 22, the second frame 23, and the third frame 24. On the other hand, referring to FIG. 9B, the sub module frame of the second sub battery module 30 may include the first frame 32 and the second frame 33. In some implementations, the sub module frame of the second sub battery module 30 may include two first frames 32.

The first frame 22 or 32 and the third frame 24 may be disposed in the stacking direction of the cell stacks 21 or 31. In the first sub battery module 20, the first frame 22 may be disposed on the bottom of the cell stack 21, and the third frame 24 may be disposed on the top. However, conversely, the third frame 24 may be disposed on the bottom of the cell stack 21, and the first frame 22 may be disposed on the top. In the second sub battery module 30, the first frames 32 may each be disposed on the top and bottom of the cell stack 31.

That is, in an embodiment of the disclosed technology, in the first sub battery module 20 disposed outside the battery module 200, the different frames may be disposed on the top and bottom of the cell stack 21, and in the second sub battery module 30 disposed inside the battery module 200, the same frames may be disposed on the top and bottom of the cell stack 31.

Although not shown in the drawing, as described above, the compressible member (not shown) may be disposed between the cell stack 21 or 31, the first frame 22 or 32, and the third frame 24. Furthermore, the compressible member may also be disposed at regular gaps or intervals between the plurality of battery cells included in the cell stacks 21 or 31.

The first frame 22 or 32 and the third frame 24 may include a connection portion 221, 241, or 321. The sub battery modules 20 and 30 may be connected and coupled to each other by using the first connection portion 221 or 321 or the second connection portion 241 to form the battery module 200.

The first frame 22 or 32 or the third frame 24 may be distinguished based on a shape of the connection portion 221, 241, or 321.

The first frame 22 or 32 or the third frame 24 may include the connection portion 221, 321, or 241 (e.g., first or second connection portion) at each of two ends in a length direction. The first connection portion 221 or 321 and the second connection portion 241 may respectively extend from the first frame 22 or 32 and the third frame 24 in a direction (e.g., X-direction in the drawings) in which the battery module 200 extends.

In addition, the first connection portion 221 or 321 and the second connection portion 241 may be thinner than the first frame 22 or 32 and the third frame 24. For example, the first connection portion 221 or 321 and the second connection portion 241 may be approximately half of the thickness of the first frame 22 or 32 and the third frame 24. Here, the thickness of the frame may indicate its length in the Z-direction.

The first frame 22 or 32 may include the first connection portion 221 or 321 extending in the direction in which the battery module 200 extends at a different height. In other words, the first connection portion 221 or 321 formed at one end of the first frame 22 or 32 in the length direction and the first connection portion 221 or 321 formed at the other end may have different positions in the Z-direction based on the drawings. Accordingly, either one of the first connection portions 221 and 321 extending from the two ends of the first frame 22 or 32 in the length direction may not be directly coupled to the second frame 23 or 33 described below.

For example, a part of the first connection portion 221 or 321 that is directly coupled to the second frame 23 or 33 may be a closed part, and its part that is not coupled to the second frame 23 or 33 may be an open part.

Referring to FIG. 9B, a gap 34 may be formed in the open part of the first frame 32, e.g., between the first connection portion 321 and the second frame 33. In the gap 34, the first connection portion 221 (a part extending from the first frame 22) of the first sub battery module 20 or its second connection portion 241 (a part extending from the third frame 24) may be disposed, or the first connection portion 321 (a part extending from the first frame 32) of the other second sub battery module 30 may be disposed. Here, the first and second connection portion 221 or 321 and 241 may be disposed in the gap 34 to overlap each other in the Z-direction based on the drawings.

The third frame 24 may include the second connection portion 241 extending in the direction in which the battery module 200 is expanded (e.g., X-direction in the drawings) at the same height. In other words, the second connection portion 241 formed at one end of the third frame 24 in the length direction and the second connection portion 241 formed at the other end may have the same position in the Z-direction based on the drawings.

Referring to FIG. 10, the second connection portion 241 extending from each of the two ends of the third frame 24 in the length direction may be directly coupled to the second frame 23 or 33 described below. That is, the second connection portion 241 may only include the closed part. The closed part may be coupled to the first connection portion 221 or 321, and may not be coupled to the connection portion if the first or second sub battery module 20 or 30 is not additionally disposed.

As discussed above, the first sub battery module 20 and the second sub battery module 30 may extend in the X-direction in the drawings by the coupling between the first connection portion 221 or 321 of the first frame 22 or 32 disposed in the stacking direction of the plurality of cells and the second connection portion 241 of the third frame 24.

In addition, the first connection portion 221 or 321 and the second connection portion 241 may include the open part having the gap formed with the second frame 23 or 33 and/or the closed part directly coupled to the second frame 23 or 33, and the first and the second sub battery modules 20 and 30 may extend by the coupling between the open part and the closed part.

For example, in the gap of the open part, the closed part (the first connection portion 221 or 321 or the second connection portion 241) of the adjacent sub battery module may be disposed, and in the closed part, the open part (the first connection portion 221 or 321) of the adjacent sub battery module may be disposed or the connection portion may not be disposed.

The second frame 23 or 33 may be disposed on the side surface of the cell stacks 21 or 31 by extending in the stacking direction (e.g., Z-direction based on the drawings) of the plurality of battery cells.

The first and second sub battery modules 20 or 30 may include at least two second frames 23 or 33, for example, two or three second frames 23 or 33.

For example, one of the plurality of second frames 23 or 33 included in the first or second sub battery module 20 or 30 may be disposed between two cell stacks 21 (21a and 21b) or 31 (31a and 31b) to simultaneously face the side surfaces of the two cell stacks 21 (21a and 21b) or 31 (31a and 31b) included in each sub battery module 20 or 30. In addition, the remaining second frame(s) 23 or 33 may be disposed to face the side surface of either one of the two cell stacks 21 (21a and 21b) or 31 (31a and 31b) included in each sub battery module 20 or 30.

The second frame 23 or 33 may function as the heat exchanger or the heat shield. When the second frame 23 or 33 functions as the heat exchanger, the second frame 23 or 33 may include the refrigerant path through which the refrigerant flows. On the other hand, if the second frame 23 or 33 functions as the heat shield, the second frame 23 or 33 may include the insulating member. Here, in some implementations, the heat exchanger and the heat shield may have structural and functional features identical or similar to those of the heat exchanger and the heat shield discussed above.

In an embodiment, the second frame 23 or 33 disposed to simultaneously face the side surfaces of two cell stacks 21 (21a and 21b) or 31 (31a and 31b) may be the heat exchanger, and the second frame 23 or 33 disposed to face the side surface of either one of two cell stacks 21 (21a and 21b) or 31 (31a and 31b) may be the heat exchanger or the heat shield.

The second frame 23 or 33 may be coupled to the first frame 22 or 32 or the third frame 24 at each of the two ends in the length direction.

FIG. 10 shows the battery module 200 including two first sub battery modules 20 and one second sub battery module 30.

As described above, in the first sub battery module 20, with the different frames, for example, the first frame 22 and the third frame 24, may respectively be disposed on the top and bottom of the cell stack 21, and in the second sub battery module 30, the same frames, for example, the first frames 32, may respectively be disposed on the top and bottom of the cell stack 31.

In some implementations, referring to FIG. 10, in two first sub battery modules 20 disposed outside the battery module 200, the first frame 22 and the third frame 24 may have different positions. For example, the first sub battery module 20 may be disposed on one side of the battery module 200 in the length direction (X-direction in the drawings), while having the first frame 22 disposed on the bottom and the third frame 24 disposed on the top. In addition, the first sub battery module 20 may be disposed on the other side of the battery module 200 in the length direction (e.g., X-direction in the drawings), while having the first frame 22 disposed on the top and the third frame 24 disposed on the bottom.

In this way, when forming the battery module 200, in two first sub battery modules 20 disposed outside the battery module 200, the first frame 22 and the third frame 24 may have different positions.

In an embodiment, the battery module 200 may include only two first sub battery modules 20 without including the second sub battery module 30.

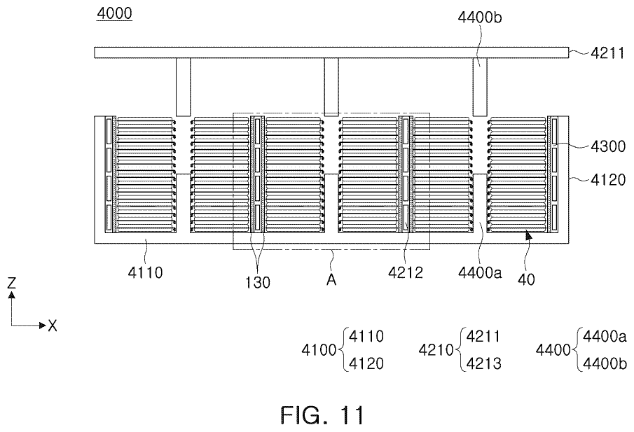

FIG. 11 is a side view of a battery pack based on an embodiment of the disclosed technology.

In an embodiment of the disclosed technology, a battery pack 4000 may include a pack housing 4100 and a pack cover 4200. In addition, the pack housing 4100 may include a tray 4110 and a side frame 4120, and although not shown in the drawing, the pack housing 4100 may include a center beam (not shown) that partitions an internal space of the pack housing 4100.

In an embodiment, a basic structure of the battery pack 4000 is the same as that of the battery pack 1000 shown in FIG. 1.

In an embodiment of the disclosed technology, a plurality of sub battery modules may be directly disposed in the pack housing 4100 of the battery pack 4000. That is, the sub battery module may be disposed directly in the pack housing 4100 without going through the sub module frame. Here, a compressible member (not shown) may be disposed between the sub battery module and the pack housing 4100.

In an embodiment of the disclosed technology, the sub battery module disposed in the battery pack 4000 may not include the sub module frame, and the battery pack 4000 may include a structure that serves as the sub module frame described above.

Referring to FIG. 11, the pack housing 4100 may include a first partition wall 4300 and a second partition wall 4400a, and the pack cover 4200 may include a second That is, the first partition wall partition wall 4400b. 4300 may be disposed in the pack housing 4100, and the second partition walls 4400 (4400a and 4400b) may be disposed in the pack housing 4100 and the pack cover 4200. Here, the second partition wall 4400a (e.g., a lower partition wall) formed on the pack housing 4100 and the second partition wall 4400b (e.g., an upper partition wall) formed on the pack cover 4200 may be coupled to each other to thus form the complete second partition wall 4400, and the pack housing 4100 and the pack cover 4200 may be coupled to each other by coupling the lower partition wall 4400a to the upper partition wall 4400b forming the second partition wall 4400.

In an embodiment of the disclosed technology, the first partition wall 4300 may function as the heat exchanger, the second partition wall 4400 may function as the heat shield. Furthermore, the second partition wall 4400 may further partition the zones partitioned by the center beam.

In an embodiment of the disclosed technology, a plurality of cell stacks 40 disposed in the zone partitioned by the center beam may correspond to the battery module described above, and at least one of the cell stack(s) 40 disposed in the zone additionally partitioned by the second partition wall 4400 may correspond to the sub battery module described above.

Referring to FIG. 11, the lower partition walls 4400a may be disposed to be spaced apart from each other in the length direction (e.g., X-direction in the drawings) of the pack housing 4100. In addition, although not shown in the drawing, the lower partition wall 4400a may have a length in a width direction (e.g., Y-direction in the drawings) of the pack housing 4100.

At least one of the cell stack(s) 40 may be disposed in the zone partitioned by the lower partition wall 4400a. The cell stacks 40 may include the plurality of battery cells stacked in one direction (Z-direction based on the drawings).

In the zone partitioned by the lower partition wall 4400a, the first partition wall 4300 may be disposed together with at least one of the cell stack(s) 40. The first partition wall 4300 may be disposed between the cell stacks 40 or between the cell stack 40 and the side frame 4120.

The first partition wall 4300 may be disposed to face a side surface of the cell stack(s) 40. Here, the heat dissipation member (not shown) may be further disposed between the cell stack(s) 40 and the first partition wall 4300 to increase the heat exchange efficiency by the first partition wall 4300. For example, the heat dissipation member may be a material having a thermal conductivity of 1 (W/mK) or more.

Referring to FIG. 11, in a state where the pack cover 4200 is not coupled to the pack housing 4100, the lower partition wall 4400a may be shorter than the first partition wall 4300 in a height direction (e.g., Z-direction in the drawings), and a height of the second partition wall 4400 may be approximately the same as a height of the first partition wall 4300 as the pack cover 4200 is coupled to the pack housing 4100. In other words, in a state where the pack cover 4200 is coupled to the pack housing 4100, the height of the second partition wall 4400 (4400a and 4400b) may be approximately the same as the height of the first partition wall 4300.

In some implementations, the pack housing 4100 and the pack cover 4200 may be coupled to each other by coupling the lower partition wall 4400a to the upper partition wall 4400b forming the second partition wall 4400.

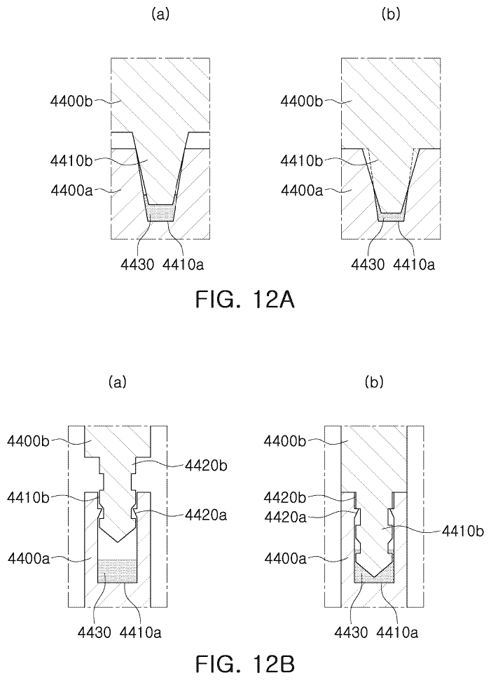

Region A in FIG. 11 is a region in which the second partition wall 4400 is formed, and FIGS. 12A and 12B are views showing various embodiments of region A of FIG. 11.

Referring to FIGS. 12A and 12B, the second partition wall 4400 may be formed by the coupling between the lower partition wall 4400a and the upper partition wall 4400b. The lower partition wall 4400a and the upper partition wall 4400b may be coupled to each other by fitting and being fixed using an adhesive material 4430.

In an embodiment, the lower partition wall 4400a may include a groove 4410a on its surface facing the upper partition wall 4400b. The adhesive material 4430 may be accommodated in the groove 4410a. The upper partition wall 4400b may include a protrusion 4410b protruding toward the lower partition wall 4400a.

The protrusion 4410b may have a shape corresponding to that of the groove 4410a to be inserted into the groove 4410a. For example, the groove 4410a may have a shape in which a width of its cross section that is increased in a coupling direction of the upper partition wall 4400b, and the protrusion 4410b may have a shape in which a width of its cross section is decreased in a coupling direction of the lower partition wall 4400a of the protrusion 4410b.

The protrusion 4410b of the upper partition wall 4400b may be force-fitted to the groove 4410a of the lower partition wall 4400a. In a state where the protrusion 4410b is force-fitted to the groove 4410a, and a part of the protrusion 4410b may be fixed by the adhesive material 4430 accommodated in the groove 4410a.

In an embodiment, the lower partition wall 4400a may include the groove 4410a and a catch 4420a protruding from an inner peripheral surface of the groove 4410a. In addition, the upper partition wall 4400b may include the protrusion 4410b and a catch protrusion 4420b protruding from an outer peripheral surface of the protrusion 4410b.

The protrusion 4410b of the upper partition wall 4400b may be force-fitted to the groove 4410a of the lower partition wall 4400a. The protrusion 4410b may be inserted into the groove 4410a until the catch protrusion 4420b and the catch 4420a come into contact with each other. The protrusion 4410b may be fixed to the groove 4410a in a state where the catch protrusion 4420b and the catch 4420a are in contact with each other. In addition, here, a part of the protrusion 4410b may be fixed by the adhesive material 4430 accommodated in the groove 4410a.

However, the lower partition wall 4400a and the upper partition wall 4400b are not limited to the structure and manner described above, and may be coupled to each other in another structure and manner to form the second partition wall 4400.

In some implementations, the insulating member (not shown) may be disposed between the cell stack(s) 40 and the second partition wall 4400. Two adjacent second partition walls 4400 may be isolated by the insulating member from the space formed by each of the second partition walls 4400. For example, the insulating member may be made of a material such as polyurethane, silicone, or the like.

As set forth above, the battery module 100 or 200 and the battery pack 1000 or 4000 including the same based on the various embodiments of the disclosed technology may be freely expanded in the horizontal, vertical, and height the size directions to be manufactured to satisfy specification required by the various vehicle models.

In addition, the battery module and the battery pack including the same based on various embodiments of the disclosed technology may reduce the manufacturing cost while improving the thermal stability and the energy density by appropriately arranging the cooling structure and/or the insulation structure between the sub battery modules 10, 20, and 30 arranged to be adjacent to one another.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

1. A battery pack comprising:
a pack housing including an internal space; and
at least one battery module accommodated in the internal space of the pack housing and including a plurality of sub battery modules,
wherein the plurality of sub battery modules includes a plurality of cell stacks, each of the plurality of cell stacks including a plurality of battery cells stacked in a first direction, the plurality of cell stacks being arranged in a second direction, and
a plurality of partition walls are disposed between the plurality of cell stacks to exchange heat with the plurality of battery cells or block thermal propagation between the sub battery modules.

2. The battery pack of claim 1, further comprising a first partition wall disposed between the plurality of cell stacks included in each of the sub battery modules and configured to exchange heat with the plurality of battery cells,
wherein the first partition wall includes a refrigerant path.

3. The battery pack of claim 2, further comprising a heat dissipation member disposed between the first partition wall and the plurality of cell stacks.

4. The battery pack of claim 2, further comprising a second partition wall disposed between the sub battery modules to insulate the sub battery modules from each other,
wherein the second partition wall includes an insulating member.

5. The battery pack of claim 2, further comprising the first partition wall disposed between the pack housing and the battery module.

6. The battery pack of claim 1, further comprising a pack cover disposed to cover the battery module,
wherein at least one of the plurality of partition walls is disposed in the pack housing or the pack cover.

7. The battery pack of claim 1, wherein the sub battery module includes a connection portion configured to allow the battery modules to be connected to each other in a second direction, and
adjacent sub battery modules are coupled to each other through the connection portion.

8. The battery pack of claim 7, wherein the battery module includes two first sub battery modules disposed outside the battery module in a length direction, and
selectively includes a second sub battery module disposed between the two first sub battery modules.

9. A battery pack comprising:
a plurality of cell stacks including a plurality of battery cells stacked in a first direction;
a pack housing including an internal space to accommodate the plurality of cell stacks; and
a pack cover coupled to the pack housing to cover the plurality of cell stacks,
wherein each of the pack housing and the pack cover includes a lower partition wall and an upper partition wall extending toward each other,
the lower partition wall and the upper partition wall cooperate to form a second partition wall that partitions the internal space, and
the second partition wall insulates at least some of the plurality of cell stacks from each other.

10. The battery pack of claim 9, further comprising a first partition wall disposed to face at least a portion of side surfaces of the plurality of cell stacks,
wherein the first partition wall includes a refrigerant path.

11. A battery module comprising a plurality of sub battery modules, each of the plurality of sub battery modules including:
first and second cell stacks each including a plurality of battery cells stacked in a first direction, the first and second cell stacks being arranged in a second direction; and
a sub module frame arranged to face the first and second cell stacks in the first direction and the second direction,
wherein the sub module frame includes a connection portion extending in the second direction from the sub module frame to allow the sub battery modules to be connected to each other in the second direction.

12. The battery module of claim 11, wherein the sub module frame includes:
first and third frames extending in the second direction and disposed on at least one of two sides in the first direction; and
a second frame extending in the first direction and disposed between at least the first and second cell stacks.

13. The battery module of claim 12, wherein the first frame includes a first connection portion including a closed part coupled to the second frame and an open part spaced apart from the second frame to form a gap, and
the third frame includes a second connection portion including a closed part coupled to the second frame.

14. The battery module of claim 13, wherein the first or second connection portion of adjacent sub battery modules is disposed in the open part.

15. The battery module of claim 12, wherein the sub battery modules include two first sub battery modules disposed outside the module in the second direction and including the first to the third frames, and
selectively include a second sub battery module disposed between the two first sub battery modules and including the first and the second frames.

16. The battery module of claim 12, wherein the second frame includes either a refrigerant path or an insulating member.
